(19) United States
(12) Patent Application Publication
(10) Pub. No.: US 2006/0062996 A1
(43) Pub. Date: Mar. 23, 2006

(54) Resin matrix composite with aluminum for lubrication in drilling

(75) Inventors: Tai-Wen Chien, Taoyuan Hsien (TW); Chun-Ching Liao, Taoyuan Hsien (TW)

Correspondence Address: TROXELL LAW OFFICE PLLC, SUITE1404, 5205 LEESBURG PIKE, FALLS CHURCH, VA, 22041, US

(73) Assignee: Yun-Chao Yeh

(21) Appl. No.: 10/945,864

(22) Filed: Sep. 22, 2004

(51) Int. Cl. B32B 15/08; B32B 15/082

(52) U.S. Cl. 428/339; 428/457; 428/461; 428/458

(57) ABSTRACT

A resin matrix composite with aluminum for lubrication in drilling comprises a resin matrix composite and an aluminum foil. The resin matrix composite is consisting of at least three of the following materials: PEG (polyethylene glycol), polyvinyl alcohol (PVA), polyoxyethylene sorbitan laurate, coconut alcohol polyethylene glycol ether, polyethylene glycol nonyl ether, castor oil polyethylene glycol ether, polyoxypropylene polyoxyethylene ether, amylum, glycerol, inorganic filler, and solvents. By one of roller coating, spin coating, film coating, static spray coating, or halftone printing, the resin matrix composite can bind the aluminum foil to form a resin matrix composite with aluminum foil for applying on PCB (printed circuit board) to function as lubricating in drilling.

### BACKGROUND OF THE INVENTION

1. Field of the Invention

The invention relates to a high-grade resin matrix composite with aluminum for lubrication in drilling, and in particular, to a high-grade resin matrix composite with aluminum for lubrication in drilling, characteristic in that it can reduce effectively the needle breaking ratio during drilling an electric board, simplifies the types of resin used and can promote production efficiency to achieve the goal of mass production, and, accordingly, is suitable for applying in an equipment for drilling an electric board.

2. Description of the Prior Art

In recent years, as the electronic technology is continuously improved, and numerous high technical electronic industries are emerging successively, more humanized and better functional electronic products are putting new ideas based on old things constantly, and these electronic products are developing continuously on a trend toward a design of low weight, as well as thin, short and small size. In every type of an electronic product, there is at least a main board consisting of many electronic elements and circuit board. The function of the circuit board comprises of supporting and connecting electrically individual electronic elements such that these electronic elements can be connected electrically with one another. The commonest circuit board at present is the printed circuit board (PCB).

A printed circuit board can connect electronic parts with one another to exert their integral function and hence is an undependable basic constitutive part in all electronic information products. Since the quality of the design of a printed circuit board not only affects the reliability of an electronic product, but also plays an important role in the competitive ability of the system, PCB is frequently called as “the mother of an electronic system product” or “the base of 3C industry”. A printed circuit board is a flat plate made of a non-conductive material. This plate is usually designed to have pre-drilled holes for installing chips and other electronic elements. Holes on elements facilitate electronically connecting printed metallic circuits pre-defined on the surface of the board. Upon penetrating connecting legs of the element through PCB, a circuit can be formed by adhering the element on the PCB with a conductive metallic welder.

However, during drilling the electric board, breakage of the drilling needle takes place frequently. Modem technology takes advantage of applying a water soluble resin over a aluminum foil to form a buffering material which, when disposing on the electric board to be drilled, the reduction of needle breaking ratio can be achieved by virtue of the wetting and buffering functions from the water soluble resin and the heat-dissipating function from the aluminum foil. Nevertheless, due to the multiplicity of formulations constituting a conventional buffering material, not only the manufacturing process is complex and the production rate becomes low, but also the stability of drilling using these buffering material is insufficient.

In view of those disadvantages associated with the conventional technique, the inventor devoted to improve it and provided finally, after an intensive study for many years, a high grade resin matrix composite with aluminum for lubrication in drilling, which can simplify the type of the resin used in the conventional technique so that the production rate can be increased to achieve the purpose of mass production, and at the same time, the needle breaking ratio can be lowered and the drilling accuracy can be raised effectively.

### SUMMARY OF THE INVENTION

One object of the invention is to provide a high-grade resin matrix composite with aluminum for lubrication in drilling, characteristic in that it can simplify the type of the resin used in the conventional technique so that the production rate can be increased to achieve the purpose of mass production.

Another-object of the invention is to provide a high-grade resin matrix composite with aluminum for lubrication in drilling, characteristic in that it can decrease the needle-breaking rate and increase effectively the drilling accuracy.

In order to achieve the above-described objects, the high grade resin matrix composite with aluminum for lubrication in drilling comprises a resin matrix composite and an aluminum foil, wherein said resin matrix composite is consisting of at least three of polyethylene glycol (PEG), polyvinyl alcohol, polyoxyethylene sorbitan laurate, polyethylene glycol lauryl ether, polyethylene glycol nonyl ether, castor oil polyethylene glycol ether, polyethylene glycol octyl ether, polyoxypropylene polyoxyethylene ether, amylum, glycerol, inorganic filler and solvents; and wherein said resin matrix composite can bind said aluminum foil through one of roller coating, spin coating, film coating, static spray coating, and halftone printing, to form a resin matrix composite with aluminum for applying over an electric board.

### BRIEF DESCRIPTION OF THE DRAWINGS

The invention, as well as its many advantages, may be further understood by the following detailed description and drawings in which:

FIG. 1 is a flowchart illustrating the fabrication of the high-grade resin matrix composite with aluminum for lubrication in drilling according to the invention.

FIG. 2 is a schematic view illustrating the formulation of the resin in Example 1 according to the invention.

FIG. 3 is a schematic view illustrating the formulation of the resin in Example 2 according to the invention.

FIG. 4 is a schematic view illustrating the formulation of the resin in Example 3 according to the invention.

FIG. 5 is a schematic view illustrating the formulation of the resin in Example 4 according to the invention.

### DETAILED DESCRIPTION OF THE PREFERRED EMBODIMENTS

As described above, the invention provides a high-grade resin matrix composite with aluminum for lubrication in drilling, characteristic in that it comprises a resin matrix composite and an aluminum foil, wherein said resin matrix composite is consisting of at least three of polyethylene glycol (PEG), polyvinyl alcohol, polyoxyethylene sorbitan laurate, polyethylene glycol lauryl ether, polyethylene glycol nonyl ether, castor oil polyethylene glycol ether, polyethylene glycol octyl ether, polyoxypropylene polyoxyethylene ether, amylum, glycerol, inorganic filler and solvents. As the inorganic filler, mention can be made of silicon dioxide (SiO₂), aluminum hydroxide (Al(OH)₃), aluminum oxide (Al₂O₃), titanium dioxide (TiO₂), calcium carbonate (CaCO₃). Suitable solvent useful in the invention may be water (H₂O)m methanol (CH₃OH), ethanol (C₂H₅OH), acetone (C₃H₇) or mixture thereof.

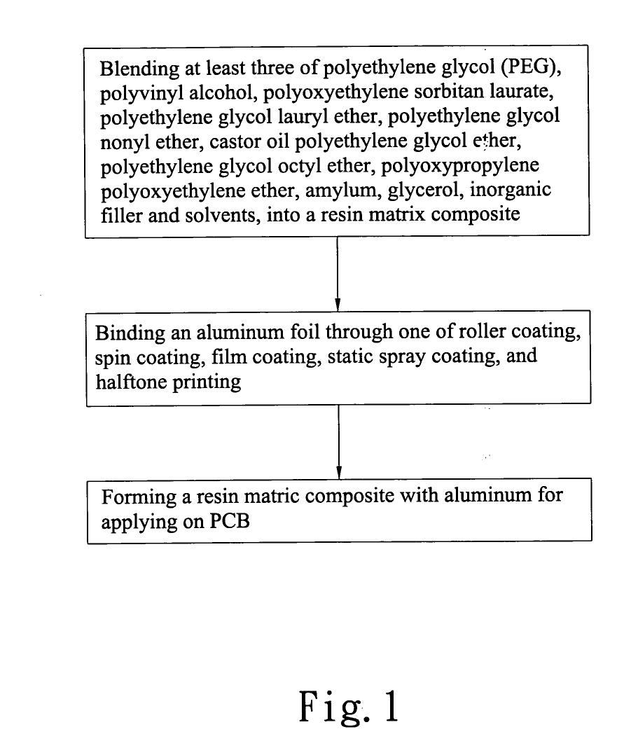

Referring to FIG. 1, when the resin described above binds said aluminum foil through one of roller coating, spin coating, film coating, static spray coating, and halftone printing, to form a composite with aluminum for applying over an electric board to be drilled. Consequently, during the drilling operation, the drilling needle can be lubricated at first with the thus-formed resin matrix composite with aluminum such that the needle-breaking ratio can be decreased and the drilling accuracy can be increased.

Among components used in the resin of the composite with aluminum according to the invention, structure of PEG can be represented as follows:
HOCH₂(CH₂OCH₂)ₙCH₂OH;
PVA as:
(CH₂CHOH)ₙ(CH₂CHOOCCH₃)ₘ
polyoxyethylene sorbitan laurate as: 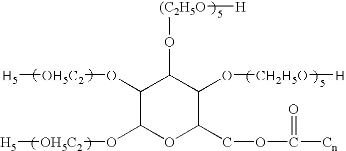
polyethylene glycol lauryl ether as: 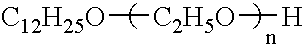
polyethylene glycol nonyl ether as: 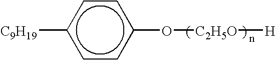
castor oil polyethylene glycol ether as: 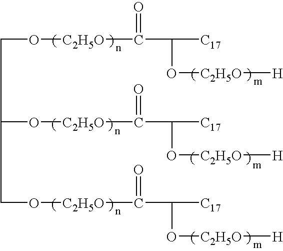
polyethylene glycol octyl ether as: 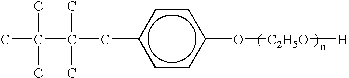
and
polyoxypropylene polyoxyethylene ether as:

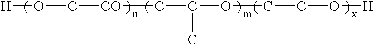

The invention will be illustrated by following non-limiting Examples, which demonstrate the formulation of four preferred experiment-proved resins according to the invention.

### EXAMPLE 1

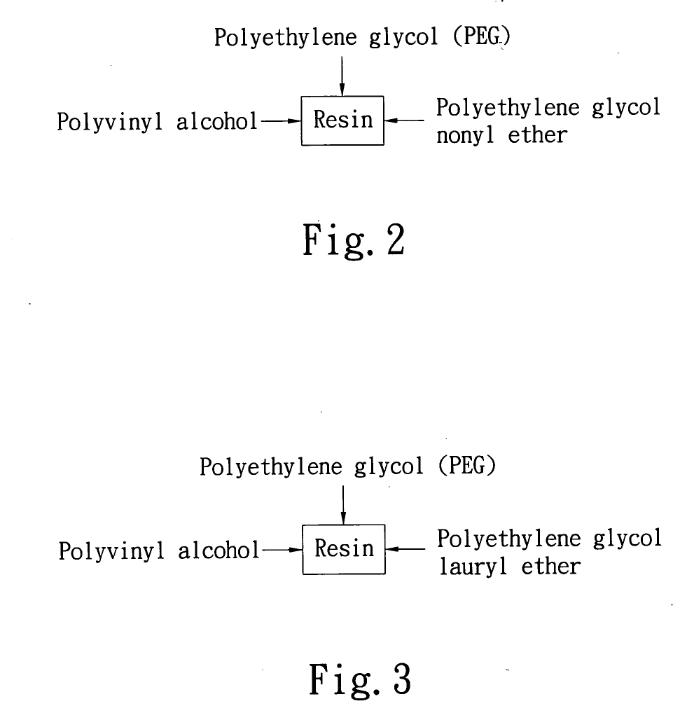

A resin is formulated by blending 41 wt %˜61 wt % of PEG with a molecular weight of 4000, 36 wt %˜56 wt % of PVA and 1 wt %˜5 wt % of polyethylene glycol nonyl ether, as shown in FIG. 2.

### EXAMPLE 2

A resin is formulated by blending 41 wt %˜61 wt % of PEG with a molecular weight of 3000, 36 wt %˜56 wt % of PVA, and 1 wt %˜3 wt % of polyethylene glycol lauryl ether, as shown in FIG. 3.

### EXAMPLE 3

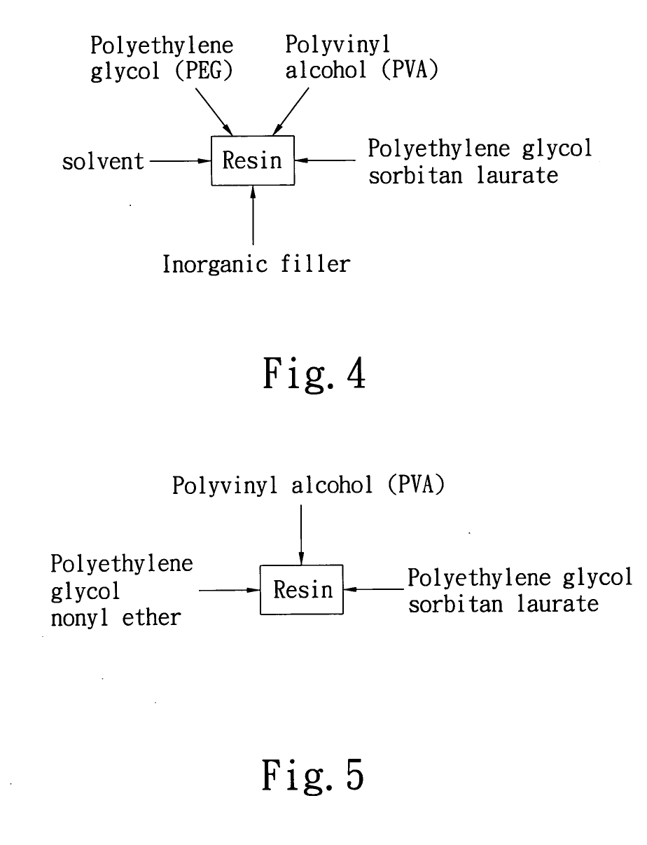

A resin is formulated by blending 32 wt %˜52 wt % of PEG with a molecular weight of 3000, 20 wt %˜40 wt % of PVA, 1 wt %˜3 wt % of polyoxyethylene sorbitan laurate and 10 wt %˜20 wt % of an inorganic filler, while adding 6˜16 wt % of acetone to adjust its viscosity, as shown in FIG. 4.

### EXAMPLE 4

A resin is formulated by blending 94 wt %˜98 wt % of PVA, 1 wt %˜3 wt % of polyoxyethylene sorbitan laurate, and 1 wt %˜3 wt % of polyethylene glycol nonyl ether, as shown in FIG. 5.

According to test results, the resin matrix composite with aluminum exhibits several following advantages over the conventional product:
1. The high grade resin matrix composite with aluminum for lubrication in drilling comprises a resin consisting essentially only of at least three of PEG, PVA, polyoxyethylene sorbitan laurate, polyethylene glycol lauryl ether, polyethylene glycol nonyl ether, castor oil polyethylene glycol ether, (polyethylene glycol octyl ether, polyoxypropylene polyoxyethylene ether, amylum, glycerol, inorganic filler and solvents; consequently, it can simplify the type of resins used in the conventional technique and can increase the production rate to achieve the purpose of mass production.
2. The resin matrix composite with aluminum according to the invention can increase effectively the drilling accuracy by up to 98%, and, by virtue of its lubrication characteristics, the needle-breaking ratio during drilling can be decreased by 20%, and hence can save the production cost and promote the precision of the product.

Accordingly, the object of the invention can be achieved by providing a high grade resin matrix composite with aluminum for lubrication in drilling, characteristic in that it can simplify the type of resins to be used, and can increase production efficiency to achieve the goal of mass production, indicating the improved applicability for industries of the invention.

While the invention has been described with reference to preferred embodiments thereof, it should be understood that the scope of the invention is not limited by these embodiments. Many changes and modifications in the above described embodiment of the invention can, of course, be carried out without departing from the scope thereof. Accordingly, to promote the progress in science and the useful arts, the invention is disclosed and is intended to be limited only by the scope of appended claims.

What is claimed is:

1. A high grade resin matrix composite with aluminum for lubrication in drilling, comprises a resin matrix composite and an aluminum foil(50˜200 μm), characteristic in that said resin is consisting essentially of at least three of polyethylene glycol (PEG ; molecular weight of 1000˜6000), polyvinyl alcohol(PVA ; molecular weight of 10000˜40000), polyoxyethylene sorbitan laurate, polyethylene glycol lauryl ether, polyethylene glycol nonyl ether, polyoxypropylene polyoxyethylene ether, inorganic filler and solvents such that said resin can bind said aluminum foil through one of roller coating, spin coating, film coating, static spray coating, and halftone printing, to form a composite with aluminum for applying over an electric board.

2. A high grade resin matrix composite with aluminum for lubrication in drilling as in claim 1, wherein said resin is prepared by blending:
a. 41 wt %˜61 wt % of PEG with a molecular weight of 4000;
b. 36 wt %˜56 wt % of PVA; and
c. 1 wt %˜5 wt % of polyethylene glycol nonyl ether.

3. A high grade resin matrix composite with aluminum for lubrication in drilling as in claim 1, wherein said resin is prepared by blending:
a. 41 wt %˜61 wt % of PEG with a molecular weight of 3000;
b. 36 wt %˜56 wt % of PVA; and
c. 1 wt %˜3 wt % of polyethylene glycol lauryl ether.

4. A high grade resin matrix composite with aluminum for lubrication in drilling as in claim 1, wherein said resin is prepared by blending:
a. 32 wt %˜52 wt % of PEG with a molecular weight of 3000;
b. 20 wt %˜40 wt % of PVA;
c. 1 wt %˜3 wt % of polyoxyethylene sorbitan laurate;
d. 6˜16 wt % of a solvent; and
e. 10 wt %˜20 wt % of an inorganic filler.

5. A high grade resin matrix composite with aluminum for lubrication in drilling as in claim 1, wherein said resin is prepared by blending:
a. 94 wt %˜98 wt % of PVA;
b. 1 wt %˜3 wt % of polyoxyethylene sorbitan laurate; and
c. 1 wt %˜3 wt % of polyethylene glycol nonyl ether.

6. A high grade resin matrix composite with aluminum for lubrication in drilling as in claim 1, wherein said inorganic filler is one of silicon dioxide (SiO₂), aluminum hydroxide (Al(OH)₃), aluminum oxide (Al₂O₃), titanium dioxide (TiO₂), and calcium carbonate (CaCO₃).

7. A high grade resin matrix composite with aluminum for lubrication in drilling as in claim 4, wherein said inorganic filler is one of silicon dioxide (SiO₂), aluminum hydroxide (Al(OH)₃), aluminum oxide (Al₂O₃), titanium dioxide (TiO₂), and calcium carbonate (CaCO₃).

8. A high-grade resin matrix composite with aluminum for lubrication in drilling as in claim 1, wherein said solvent is one of water (H₂O), methanol (CH₃OH), ethanol (C₂H₅OH), and acetone (C₃H₇O).

9. A high-grade resin matrix composite with aluminum for lubrication in drilling as in claim 4, wherein said solvent is one of water (H₂O), methanol (CH₃OH), ethanol (C₂H₅OH), and acetone (C₃H₇O).

10. A high grade resin matrix composite with aluminum for lubrication in drilling as in claim 1, wherein said resin contains further one of amylum, glycerol, castor oil polyethylene glycol ether, and polyethylene glycol octyl ether.
